(19) United States
(12) Patent Application Publication
(10) Pub. No.: US 2013/0050905 A1
(43) Pub. Date: Feb. 28, 2013

(54) CUBICLE TYPE GAS-INSULATED SWITCHGEAR WITH WITHDRAWABLE CIRCUIT BREAKER PART

(71) Applicant: Min Hyung KIM, Ulsan (KR)

(72) Inventor: Min Hyung KIM, Ulsan (KR)

(73) Assignee: HYUNDAI HEAVY INDUSTRIES CO., LTD., Ulsan (KR)

(21) Appl. No.: 13/341,573

(22) Filed: Dec. 30, 2011

(30) Foreign Application Priority Data
Aug. 31, 2011 (KR) PCT/KR2011/087590

(51) Int. Cl. H02B 11/173

(52) U.S. Cl. 361/608

(57) ABSTRACT

Provided is a GIS (Gas Insulated Switchgear) with a withdrawable circuit breaker unit including a main bus compartment having a main bus-bar unit, a transfer bus compartment including a transfer bus-bar unit, a sealing circuit breaker compartment including a circuit breaker unit and an outgoing compartment including a current transforming unit and a cable terminal being electrically coupled to the transfer bus-bar unit. The circuit breaker unit is contained in the sealing circuit breaker compartment that is separately independent from other compartments. The circuit breaker unit is withdrawn and inserted without interrupting power supply of the outgoing compartment. The circuit breaker unit is electrically coupled to or isolated with the main bus-bar unit and the current transforming unit according to whether the circuit breaker unit is withdrawn from or inserted to the sealing circuit breaker compartment. The sealing circuit breaker compartment and the outgoing compartment do not share insulation gas.

### CROSS-REFERENCE TO RELATED APPLICATIONS

This application claims foreign priority under 35 U.S.C. §119 to Korean Patent Application No. 10-2011-0087590 filed Aug. 31, 2011 with the Korean Intellectual Property Office, which is hereby incorporated by reference in its entirety.

### FIELD OF THE INVENTION

This application relates to a GIS (Gas Insulated Switchgear), and more particularly to a GIS with a withdrawable circuit breaker unit that is maintainable and replaceable without interrupting power supply through use of a transfer bus-bar unit.

### BACKGROUND OF THE INVENTION

In general, a GIS (Gas Insulated Switchgear) includes a circuit breaker unit, a disconnecting switch unit, a ground switch unit, a potential current transforming unit, a main bus-bar unit and so on in a grounded metal tank. The inner of the GIS is filled with Sulfur Hexafluoride (SF6) gas excellent for insulation and arc extinction, and the GIS has advantages for substation miniaturization, improvement of safety and reliability, easy operation and maintenance, and so on.

GIS is a distributing board that contains high or medium voltage electrical devices in a pressure-resistant tank with SF6 gas.

A conventional GIS contains the circuit breaker unit, a current transforming unit and a cable terminal in a single sealing container and shares insulating gas (e.g., SF6 gas). Therefore, the conventional GIS inevitably interrupts power supply and necessarily emits the insulating gas from the sealing container for maintenance or replacement of circuit breaker unit.

### SUMMARY OF THE INVENTION

To address the above-discussed problems occurring in the prior art, one aspect of this application provides a GIS (Gas Insulated Switchgear) with a circuit breaker unit that is contained in a separately independent sealing circuit breaker compartment and is maintainable and replaceable without interrupting power supply through use of a transfer bus-bar unit.

Another aspect of this application is to provide a withdrawable circuit breaker unit quickly enabling maintenance and replacement.

Still another aspect of this application is to detach a circuit breaker unit in an independent compartment so that time consumed in insulating gas replacement is shortened and an amount of insulating gas is saved.

In some embodiments, a GIS (Gas Insulated Switchgear), with a withdrawable circuit breaker unit, includes a main bus compartment including a main bus-bar unit, a transfer bus compartment including a transfer bus-bar unit, a sealing circuit breaker compartment including a circuit breaker unit and an outgoing compartment including a current transforming unit and a cable terminal being electrically coupled to the transfer bus-bar unit. The circuit breaker unit is contained in the sealing circuit breaker compartment being separately independent from other compartments. The circuit breaker unit is withdrawn and inserted without interrupting power supply of the outgoing compartment. The circuit breaker unit is electrically coupled to or isolated with the main bus-bar unit and the current transforming unit according to whether the circuit breaker unit is withdrawn from or inserted to the sealing circuit breaker compartment. The sealing circuit breaker compartment and the outgoing compartment do not share insulation gas.

In one embodiment, the circuit breaker unit may be withdrawn from or inserted to, in a sliding fashion, the sealing circuit breaker compartment between main bus compartment and the outgoing compartment.

In one embodiment, when the circuit breaker unit is withdrawn, the GIS may apply an electric current from the transfer bus-bar unit to the current transforming unit and the cable terminal.

In one embodiment, the GIS further includes a gas duct between the main bus compartment and transfer bus compartment, the main bus compartment and the transfer bus compartment being arranged side by side. The gas duct is configured to emit gas generated inside the main bus compartment, the transfer bus compartment, and the sealing circuit breaker compartment.

Accordingly, the CGIS described in this application has at least the advantages described below.

The CGIS may contain a circuit breaker unit located in a separately independent sealing circuit breaker compartment, and may maintain and replace the circuit breaker unit without interrupting power supply through use of a transfer bus-bar unit.

The CGIS may quickly maintain and replace a circuit breaker compartment by withdrawing the circuit breaker unit in a sliding way.

The CGIS may minimize a size of a gas tank (i.e. sealing circuit breaker compartment) for a circuit breaker compartment by separately configuring the gas tank, and may shorten time and save an amount of gas by locally replacing the gas tank.

### BRIEF DESCRIPTION OF THE DRAWINGS

FIG. 1 is a side cross sectional diagram illustrating a GIS (Gas Insulated Switchgear) with a withdrawable circuit breaker unit according to an example embodiment of the described technology.

FIG. 2 is a side cross sectional diagram illustrating the GIS when the circuit breaker unit is withdrawn.

### DETAILED DESCRIPTION OF THE INVENTION

Embodiments of the described technology now will be described more fully with reference to the accompanying drawings, in which embodiments of this technology are shown. This technology may, however, be embodied in many different forms and should not be construed as limited to the embodiments set forth herein. Rather, these embodiments are provided so that this disclosure will be thorough and complete, and will fully convey the scope of this technology to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

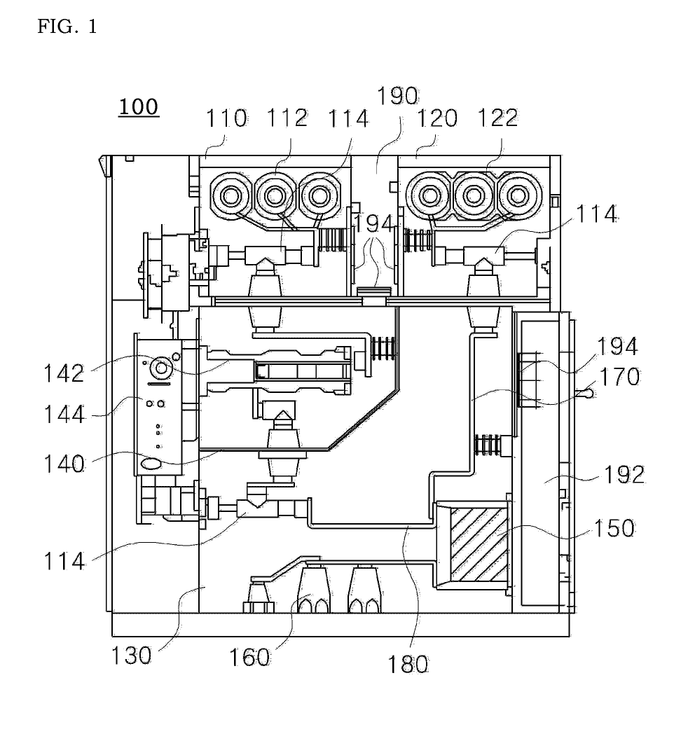

Referring to FIG. 1, a GIS 100 includes a main bus compartment 110, a transfer bus compartment 120, a outgoing compartment 130, a sealing circuit breaker compartment 140, a first gas duct 190 and a second gas duct 192. The GIS configures the circuit break unit 142 with a withdrawable type.

The main bus compartment 110 may be configured with a first compartment filled with insulation gas and the first compartment contains a main bus-bar unit 112 and a three-phase switch unit 114a connected with the main bus-bar unit 112.

The transfer bus compartment 120 may be configured with a second compartment filled with insulation gas and the second compartment contains a transfer bus-bar unit 122 and a three-phase switch unit 114b connected with the transfer bus-bar unit 122.

The outgoing compartment 130 may be configured with a third compartment filled with insulation gas and the third compartment contains a current transforming unit 150, a cable terminal 160, a transfer conducting bus-bar 170, a main conducting bus-bar 180 and a three-phase switch unit 114c connecting the circuit breaker unit 142.

Herein, the transfer bus-bar unit 122 is contained in the transfer bus compartment 120 and is electrically connected to the current transforming unit 150 through use of the transfer conducting bus-bar 170. The circuit breaker unit 142 is contained in the sealing circuit breaker compartment 140 and is electrically connected to the current transforming unit 150 through use of the main conducting bus-bar 180. The current transforming unit 150 is electrically connected to the cable terminal 160 arranged in a bottom of the outgoing compartment 130

In one embodiment, the three-phase switch 114 is arranged in a connecting part of the sealing circuit breaker compartment 140 and the conducting bus-bar 180 to be switched to a grounding state, a disconnecting state a current applying state.

The sealing circuit breaker compartment 140 is a separately independent compartment. The circuit breaker unit 142 is contained in the inner of the sealing circuit breaker compartment 140 and a circuit breaker driving unit 144 is attached in the outer of the sealing circuit breaker compartment 140.

The circuit breaker unit 142 is withdrawn from and inserted to the sealing circuit breaker compartment 140. When the circuit breaker unit 142 is withdrawn from the sealing circuit breaker compartment 140, the circuit breaker unit 142 detaches a main bus-bar unit 112 in the main bus compartment 110 and the current transforming unit 150 in the outgoing compartment 130. When the circuit breaker unit 142 is inserted to the sealing circuit breaker compartment 140, the circuit breaker unit 142 electrically connects a main bus-bar 112 in the main bus compartment 110 and the current transforming unit 150 in the outgoing compartment 130.

Herein, the outgoing compartment 130 is configured in a structure that may contain the sealing circuit breaker compartment 140. Also, the outgoing compartment 130 and the sealing circuit breaker compartment 140 are configured in a separately independent tank thereby not sharing insulation gas.

The first gas duct 190 and the second gas duct 192 respectively provide a path for emitting hot gas due to arc generated by operations of devices inner of a tank. In one embodiment, the main bus compartment 110 and the transfer bus compartment 120 may be arranged side by side and the sealing circuit breaker compartment 140 may be arranged in a bottom of the main bus compartment 110. Also, the first gas duct 190 is arranged between the main bus compartment 110 and the transfer bus compartment 120. Hot gas due to arc generated inside of the main bus compartment 110, the transfer bus compartment 120 and the sealing circuit breaker compartment 140, emits through the first gas duct 190. Herein, the hot gas may emit gas outlets in the main bus compartment 110, the transfer bus compartment 120 and the sealing circuit breaker compartment 140 and each of the gas outlets is connected with the first gas duct 190.

The second gas duct 192 may be configured in a rear side of the GIS 100 and hot gas generated inner of the outgoing compartment 130 may emit through the second gas duct 192.

In a normal current applying state, the circuit breaker unit 142 is inserted to the sealing circuit breaker compartment 140 and a current is flown from the main bus-bar unit 112 to the cable terminal 160 through the circuit breaker unit 142, the main bus-bar unit 180 and the current transforming unit 150.

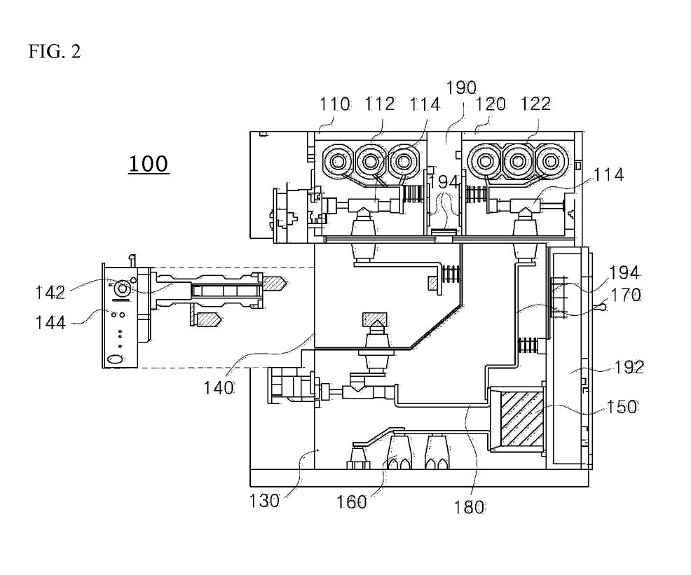

As shown in FIG. 2, the circuit breaker unit 142 may be withdrawn from the sealing circuit breaker compartment 140 in a direction of a front side of the GIS 100. In one embodiment, the circuit breaker unit 142 may be withdrawn from or inserted to the sealing circuit breaker compartment 140 in a sliding way. That is, the circuit breaker unit 142 may be inserted to the sealing circuit breaker compartment 140 to assemble the GIS 100 and withdrawn from the sealing circuit breaker compartment 140 to dissemble the GIS 100, like a desk drawer. During operations (i.e., withdrawal and insertion) of the circuit breaker unit 142, the GIS 100 emits insulation gas in the sealing circuit breaker compartment 140 and maintains insulation gas filled with the outgoing compartment 130.

In one embodiment, when the circuit breaker unit 142 is withdrawn from the sealing circuit breaker compartment 140, a current may be applied from the transfer bus-bar unit 122 contained in the transfer bus compartment 120 to the current transforming unit 150 and the cable terminal 160 through the transfer conducting bus-bar 170.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A GIS (Gas Insulated Switchgear) including a withdrawable circuit breaker unit, the GIS comprising:
a main bus compartment including a main bus-bar unit, a transfer bus compartment including a transfer bus-bar unit, a sealing circuit breaker compartment including a circuit breaker unit, an outgoing compartment including a current transforming unit, and a cable terminal being electrically coupled to the transfer bus-bar unit,
wherein the circuit breaker unit is contained in the sealing circuit breaker compartment, the sealing circuit breaker compartment being separately independent from other compartments,
wherein the circuit breaker unit is configured to be withdrawn and inserted without interrupting power supply of the outgoing compartment,
wherein the circuit breaker unit is electrically coupled to or isolated with the main bus-bar unit and the current transforming unit according to whether the circuit breaker unit is withdrawn from or inserted to the sealing circuit breaker compartment, and
wherein the sealing circuit breaker compartment and the outgoing compartment do not share insulation gas.

2. The GIS of claim 1, wherein the circuit breaker unit is withdrawn from or inserted to, in a sliding fashion, the sealing circuit breaker compartment between main bus compartment and the outgoing compartment.

3. The GIS of claim 1, wherein when the circuit breaker unit is withdrawn, the GIS applies an electric current from the transfer bus-bar unit to the current transforming unit and the cable terminal.

4. The GIS of claim 1, further comprising:
a gas duct being between the main bus compartment and transfer bus compartments, the main bus compartment and the transfer bus compartment being arranged side by side,
wherein hot gas due to arc generated inner of the main bus compartment, the transfer bus compartment, and the sealing circuit breaker compartment emits through the gas duct.
